(19) United States
(12) Patent Application Publication
(10) Pub. No.: US 2018/0101664 A1
(43) Pub. Date: Apr. 12, 2018

(54) QSAR TOXICITY PREDICTION METHOD FOR EVALUATING HEALTH EFFECT OF NANO-CRYSTALLINE METAL OXIDE

(71) Applicant: Chinese Research Academy of Environmental Sciences, Beijing (CN)

(72) Inventors: YUNSONG MU, BEIJING (CN); Fengchang WU, BEIJING (CN); Fuhong SUN, BEIJING (CN); Huixian LI, BEIJING (CN); Haiqing LIAO, BEIJING (CN); Yingchen BAI, BEIJING (CN); Chengfang PANG, BEIJING (CN)

(73) Assignee: Chinese Research Academy of Environmental Sciences

(21) Appl. No.: 15/839,850

(22) Filed: Dec. 13, 2017

Related U.S. Application Data
(63) Continuation of application No. PCT/CN2015/088336, filed on Aug. 28, 2015.

(30) Foreign Application Priority Data
Jun. 16, 2015 (CN) 201510333022.4

(51) Int. Cl. G06F 19/00; G06F 17/12

(52) U.S. Cl. CPC G06F 19/704; G06F 2217/16; G06F 17/12

(57) ABSTRACT

The present invention relates to a QSAR toxicity prediction method for evaluating health effects of nano-crystalline metal oxides, and relates to the field of prediction of toxic substances in an environment. The QSAR toxicity prediction method specifically comprises: predicting a toxicity endpoint of an unknown metal oxide according to a quantitative relationship between structural characteristics and a cytotoxic effect of a nano-crystalline metal oxides.

### CROSS-REFERENCE TO RELATED APPLICATIONS

This application is a continuation of International Patent Application No. PCT/CN2015/088336 with a filing date of Aug. 28, 2015, designating the United States, now pending, and further claims priority to Chinese Patent Application No. 201510333022.4 with a filing date of Jun. 16, 2015. The content of the aforementioned applications, including any intervening amendments thereto, are incorporated herein by reference.

### TECHNICAL FIELD

The present invention relates to the field of prediction of toxic substances in an environment, and particularly relates to a QSAR toxicity prediction method for evaluating a health effect of nano-crystalline metal oxide.

### BACKGROUND OF THE PRESENT INVENTION

People are greatly benefited from fruitful achievements gained based on nanotechnology. Nanometer materials have been widely applied to daily supplies, and have wider application prospects in biomedical fields such as drug carriers, cancer therapy, gene therapy, antibacterial materials, medical diagnosis, biosensors and the like. Nano-crystalline metal oxide is an important component of industrially produced nanoparticles and have high application values in aspects such as foods, materials, environmental protection, chemistry, biomedicine and the like. However, people increasingly care about nanometer characteristics of the nanometer materials, such as small size effects, surface and interfacial effects, quantum size effects and the like. A special biological effect may be initiated; human health may be threatened; and negative effects may be brought to the environment and society. In view of this, characteristics of the nano-crystalline metal oxide need to be reflected; a basis convenient for safety application needs to be provided; cognition of nano-toxicity plays a key role; and necessary safety evaluation of nano-products is facilitated.

Study on biotoxicity and health effects of metal oxides at a nanoscale has become a research hotspot in recent decades. Compared with a toxic effect of a nano metal element, a toxication mechanism of the metal oxides may be more complicated. Meanwhile, nano-crystalline metal oxides of different elements may have similar active sites and toxication mechanisms. A dose-response relationship and a predictive model have important significances at theoretical and practical levels. An original intention of a QSAR technology is to predict the toxicity of an untested compound, and the knowledge is applied to risk assessment. With respect to a series of substances with the same action mode, a relationship between structural parameters and biological activity or toxicity of the compound is established by virtue of statistical means, and an influence on the activity or toxicity of an unknown compound is further predicted. In the recent decades, study on QSAR at the nanoscale is very active. Winkler et al. analyzed a current situation of QSAR study on nano toxicity effects and predicted potential applications. It is thought that the method can optimize resources in toxicology survey and reduce moral and monetary cost of toxicity tests, Wolterbeek and Walker summarized physical and chemical properties of 20 cations and potential toxicity effects of different species and recognize and interpret toxic action modes. An appropriate compound classification and cross reference method is developed to perform preliminary hazardous risk assessment on the nanometer materials. Meng considered that the QSAR method for acquiring a correct toxicological path and a damage mechanism may play a crucial role in safety assessment of the nanometer materials. Pathakoti et al. determined toxicities of 17 nano-crystalline metal oxides to Escherichia coli, and established a two-parameter QSAR model based on the toxicities to predict light-free (F=33.83, R²=0.87) and light-induced (F=20.51, R²=0.804) toxicity effects. Epa et al. established a quantitative prediction model for ingestion and apoptosis of nanoparticle-induced pancreatic cancer cell multi-type cells PaCa2 and human umbilical vein endothelial cells and respectively proposed modeling strategies for different modifications on surfaces of different materials and the same material. Toropova et al. proposed an optimal descriptor independent of a space structure and established a toxicity prediction model of Escherichia coli. Although Leszczynski preliminarily established a toxicity prediction model of 13 nano-crystalline metal oxides, a predicted effect and an application field of the model need to be further researched and demonstrated.

In general, the above method is only used for performing preliminary model prediction on toxicities of nano-crystalline metal oxides. Qualitative mode recognition and quantitative prediction of toxicity effects of the nano-crystalline metal oxides lack of systematic research and reliable prediction methods.

In view of the above defects, an inventor in the present invention finally achieves the present invention after long-term research and practice.

### SUMMARY OF PRESENT INVENTION

A purpose of the present invention is to provide a QSAR toxicity prediction method for evaluating a health effect of nano-crystalline metal oxide, so as to overcome the above technical defects.

In order to achieve the above purpose, the present invention provides a toxicity prediction method based on a quantitative structure-activity relationship of nano-crystalline metal oxide. A toxicity endpoint of unknown nano-crystalline metal oxide is predicted according to a quantitative relationship between structural characteristics and a cytotoxic effect of the nano-crystalline metal oxide.

The toxicity prediction method specifically comprises the following steps:

step a, acquiring, screening, calculating and summarizing modeling toxicity data;

step b, establishing a structural descriptor dataset of nano-crystalline metal oxides, and performing linear correlation analysis and principal component analysis by taking a structural parameter corresponding to each metal oxide as an independent variable, thereby obtaining an optimal structural descriptor combination,

wherein the established structural descriptor dataset of the nano-crystalline metal oxides respectively comprises a soft index of metal ion σp, a soft index per unit charge σP/Z, an atomic number AN, an ion radius r, IP: ionic potential of O_{N}-state ion, IP(N+1): ionic potential of O_{N+1}-state ion, a difference ΔIP of IP(N+1) and IP, an atomic radius R, an atomic weight AW, a Pauling electronegativity Xₘ, a covalence index Xₘ²r, an atomic ionization potential AN/ΔIP, a first hydrolysis constant |log K_{OH}|, an electrochemical potential ΔE₀, an atomic size AR/AW, measured electronegativity x, polarizability z/rx, ionic valency Z, polarizing force parameters Z/r, Z/r² and Z²/r, polarizing force-like parameters Z/AR and Z/AR², a formation enthalpy ΔHme⁺ of gaseous cations, an energy barrier GAP and standard heat of formation HoF of an oxide cluster.

The step b specifically comprises the processes as follows:

step b1, taking a toxicity endpoint as a dependent variable, performing linear correlation analysis by taking a structural parameter corresponding to each metal oxide as an independent variable, and calculating a correlation coefficient r according to a formula (1) as follows:

$$r = \frac{{\sum }_{i = 1}^{n} ( {x}_{i} - \overline{x} ) ( {y}_{i} - \overline{y} )}{\sqrt{{\sum }_{i = 1}^{n} {( {x}_{i} - \overline{x} )}^{2} {( {y}_{i} - \overline{y} )}^{2}}} \qquad ( 1 )$$

in the formula, x and y respectively represent the average values of structural parameters and toxicity values, and xᵢ and yᵢ respectively represent a structural parameter and a toxicity value corresponding to the ith metal;

the correlation coefficient r>0.8 is a significant correlation parameter;

in the step b2, the optimal structural descriptor combination is obtained through principal component analysis on premise of significant correlation. A specific formula is as follows:

F=a₁ᵢ*Z_{X1}+a₂ᵢ*Z_{X2}+ . . . +aₚᵢ*Z_{Xp} (2)

wherein a₁ᵢ, a₂ᵢ, . . . , aₚᵢ(i=1, . . . , m) are characteristic vectors corresponding to characteristic values of a covariance matrix Σ of X, and Z_{X1}, Z_{X2}, . . . , Z_{Xp} are values obtained by performing standardized processing on original variables;

A=(aᵢⱼ)_{p×m}=(a₁,a₂, . . . , aₘ) (3)

Rₐᵢ=λᵢₐᵢ (4)

R is a correlation coefficient matrix; λᵢ and ₐᵢ are a corresponding characteristic value and a unit characteristic vector; and λ1≥λ2≥ . . . ≥λp≥0.

Step c, establishing a toxicity prediction model and checking robustness; establishing a multiple regression equation, estimating parameters, and checking by adopting a value P corresponding to a statistic F;

specifically, step c1, establishing the multiple regression equation and estimating the parameters;

two optimal structural parameters determined in the step c refer to the independent variable X; a cytotoxicity value of the metal oxide is a dependent variable Y; a QICAR equation Y=XB+E of each model organism is established by utilizing a multiple linear regression analysis method, as shown in a formula (5):

$$Y = ( \begin{matrix}{y}_{1} \\ {y}_{2} \\ ⋮ \\ {y}_{n}\end{matrix} ) , X = ( \begin{matrix}1 & {x}_{11} & {x}_{12} \\ 1 & {x}_{21} & {x}_{22} \\ ⋮ & ⋮ & ⋮ \\ 1 & {x}_{n 1} & {x}_{n 2}\end{matrix} ) , B = ( \begin{matrix}{β}_{0} \\ {β}_{1} \\ {β}_{2}\end{matrix} ) , E = ( \begin{matrix}{ɛ}_{1} \\ {ɛ}_{2} \\ ⋮ \\ {ɛ}_{n}\end{matrix} ) \qquad ( 5 )$$

wherein n is a number of observed values;

parameters in the equation are estimated by adopting a least square method, and X′ is a transposed matrix of X:

$$\hat{β} = ( \begin{matrix}{\hat{β}}_{0} \\ {\hat{β}}_{1} \\ … \\ {\hat{β}}_{m}\end{matrix} ) = {( {X}^{′} X )}^{- 1} {X}^{′} Y \qquad ( 6 )$$

step c2, performing goodness-of-fit test and significance test of the regression equation, and testing by adopting the F;

goodness-of-fit test indexes of the model refer to: square R² of the correlation coefficient and correlation coefficient R̅² of degree-of-freedom correction, and a standard deviation of RMSE;

indexes of F test refer to a value F and correlative probability p (Significance F) calculated by multi-factor variance analysis (Multi-ANOVA); and test is performed by adopting the value P corresponding to the statistic F;

step c3, judgment standards: according to a toxicity data acquisition way, in vitro test R²≥0.81, and in vivo test R²≥0.64; a significance level is α, and when p<α, the regression equation is significant.

Calculation is made in the step c3 according to a formula as follows:

$$\begin{matrix} {R}^{2} = 1 - \frac{{\sum }_{i = 1}^{n} {( {y}_{i} - \hat{y} )}^{2}}{{\sum }_{i = 1}^{n} {( {y}_{i} - \overline{y} )}^{2}} & ( 7 ) \\ \overline{{R}^{2}} = 1 - ( 1 - {R}^{2} ) \frac{n - 1}{n - 3} & \\ RMSE = \sqrt{\frac{{\sum }_{i = 1}^{n} {( {y}_{i} - \hat{y} )}^{2}}{n - 3}} & ( 8 ) \\ F = \frac{[ SS ( total ) - SS ( residual ) ] / 2}{ss ( residual ) / ( n - 3 )} = \frac{[ {\sum }_{i = 1}^{n} {( {y}_{i} - \overline{y} )}^{2} - {\sum }_{i = 1}^{n} {( {y}_{i} - \hat{y} )}^{2} ] ( n - 3 )}{2 \times {\sum }_{i = 1}^{n} {( {y}_{i} - \hat{y} )}^{2}} & ( 9 )\end{matrix}$$

in the formula, R² represents the square of the correlation coefficient, R̅² represents a correlation coefficient of degree-of-freedom correction, and RMSE represents the standard deviation;

step d, performing internal validation on a QSAR model;

the step d comprises a specific process as follows:

step d1, taking a sample as a prediction set in given modeling samples, modeling the rest samples as a training set, and calculating a prediction error of the sample;

step d2, recording the sum of the squares of prediction errors in each equation until all the samples are forecast once only;

step d3, calculating a cross validation correlation coefficient Q²_{cv} and a cross validation root-mean-square error RMSECV, wherein the determining criteria include Q²_{cv}>0.6 and R²−Q²_{cv}≤0.3;

calculation formulas adopted in the step d3 are as follows:

$$\begin{matrix}{Q}_{CV}^{2} = 1 - \frac{{\sum }_{i = 1}^{n} {( {y}_{i}^{obs} - {y}_{i}^{predcv} )}^{2}}{{\sum }_{i = 1}^{n} {( {y}_{i}^{obs} - {y}_{i}^{- obs} )}^{2}} & ( 10 ) \\ RMSECV = \sqrt{\frac{{\sum }_{i = 1}^{n} {( {y}_{i}^{obs} - {y}_{i}^{predcv} )}^{2}}{n}} & ( 11 )\end{matrix}$$

in the formula, yᵢ^{obs} represents a measured value of toxicity of the ith compound, yᵢ^{predcv} represents a predicted value of the toxicity of the ith compound, y̅^{obs} represents an average value of toxicity of the training set, and n represents a number of compounds in the training set;

step e, calculating an application field of the model; and drawing a Williams diagram by taking a leverage value h as a horizontal coordinate, taking a standardized residual of each data point as a vertical coordinate by virtue of the tested model;

in the step e, a calculation formula of the leverage value h, is as follows:

hᵢ=xᵢ^{T}(X^{T}X)⁻¹xᵢ (12)

in the formula, xᵢ represents a column vector composed of structural parameters of the ith metal; for a two-parameter model,

$${x}_{i} = ( \begin{matrix}{x}_{i 1} \\ {x}_{i 2}\end{matrix} ) , X = ( \begin{matrix}{x}_{11} & {x}_{12} \\ {x}_{21} & {x}_{22} \\ ⋮ & ⋮ \\ {x}_{n 1} & {x}_{n 2}\end{matrix} ) ,$$

X^{T} represents a transposed matrix of the matrix X, and (X^{T}X)⁻¹ represents an inverse matrix of a matrix X^{T}X;

a calculation formula of a critical value h* is as follows:

$${h}^{*} = \frac{3 ( p + 1 )}{n} \qquad ( 13 )$$

in the formula, p represents a variable number in the model; p is equal to 2 in the two-parameter model; and n represents a number of compounds in the model training set, and is determined according to a number of metal oxides in the training set in the QSAR equation after test in the steps a-d;

a coordinate space of h<h* in the Williams diagram is the application field of the model; and

step f, rapidly screening and predicting the toxicity of unknown nano-crystalline metal oxides.

A specific process is as follows: obtaining a nano QSAR prediction equation according to method in the above steps a-e, searching and sorting values of all structural descriptors of to-be-predicted nano-crystalline metal oxides, and substituting the values into the equations to calculate a to-be-predicted toxicity endpoint.

According to the QSAR toxicity prediction method for evaluating the health effects of the nano-crystalline metal oxides provided in the present invention, the toxicity prediction model is established based on the action modes and toxication mechanisms of the nano-crystalline metal oxides. The unknown toxicity value is predicted by the QSAR modeling method; the method is rapid and simple; and prediction of the toxicity endpoint of multiple compounds lacking of toxicity data is completed depending on less test data.

### DESCRIPTION OF THE DRAWINGS

FIG. 1 is a flow chart of a prediction method in the present invention;

FIG. 2 is a Williams diagram 1 for evaluation of an application field of a model in the present invention; and

FIG. 3 is a Williams diagram 2 for evaluation of an application field of a model in the present invention.

### DETAILED DESCRIPTION OF PREFERRED EMBODIMENTS

The above and additional technical features and advantages of the present invention are described in detail below in combination with drawings.

A principle of the present invention is to predict a toxicity endpoint of an unknown oxide according to a quantitative relationship between structural characteristics and a cytotoxic effect of a nano-crystalline metal oxides. The method in the present invention is a method for establishing a nano metal toxicity prediction model in combination with physicochemical structural parameters and toxication mechanisms of nano-crystalline metal oxides and applying the toxicity prediction model to predicting the toxicity endpoint of the unknown nano-crystalline metal oxides.

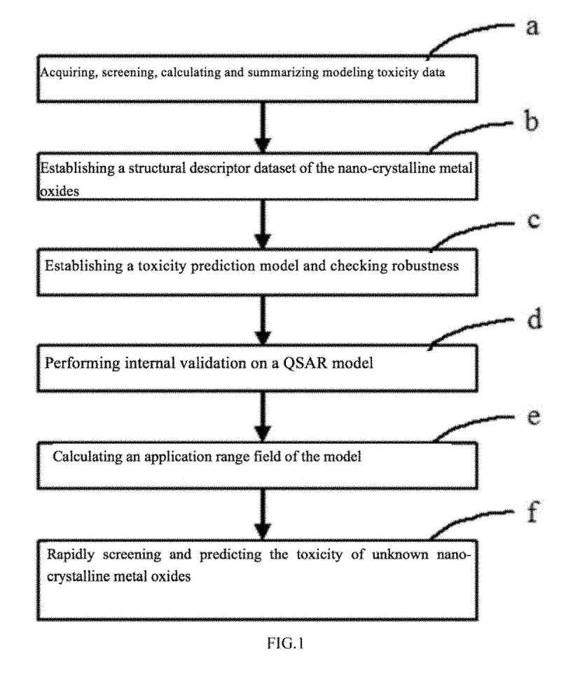

FIG. 1 is a flow chart of a QSAR toxicity prediction method for evaluating health effects of nano-crystalline metal oxides in the present invention. A specific process is as follows:

step a, acquiring, screening, calculating and summarizing modeling toxicity data;

step a1, a data acquisition process;

step a2, a data screening process; conditions for the data screening are as follows:

1) cytotoxicity data of all nano-crystalline metal oxides shall come from the same test source, the same research group and same test condition;

2) toxicity endpoint data types include a fatality rate, a growth rate and a reproductive rate, represented as EC₅₀ or LC₅₀;

3) toxicity test must be implemented through standard operation procedures under environmental conditions in a certain range; and

4) biological test exposure time is 48-96 hours, and a particle size of nano-crystalline metal oxides is between 30 nm and 100 nm;

step a3, a data calculation process, wherein a calculation method in embodiments of the present invention is as follows:

a concentration of an aqueous solution of the nano-crystalline metal oxides serves as a measurement index of data, e.g., a unit obtained by dividing a mass concentration by a molecular weight is transformed into a molar concentration, that is, mol/L;

step a4, a data summarizing process:

a finally obtained dataset includes molecular formulas of the nano-crystalline metal oxides, types of tested cells, toxicity effect types, endpoint indexes, test conditions, exposure time and data sources.

A detailed toxicity data acquisition process is as follows:

Acute toxicity data for modeling is preferentially collected from the ECOTOX Database (http://cfpub.epa.gov/ecotox/) of the United States Environmental Protection Agency. If toxicity data is insufficient, valid data (ISIWebofKnowledge) queried by SCI (Science Citation Index) in recent 10 years serves as a supplement. Names of the nano-crystalline metal oxides, names of to-be-tested species, acute toxicity and other key words are input by virtue of the database and a document retrieval engine, and a toxicity dataset meeting the conditions is exported. Qualified toxicity data is screened on premise of meeting conditions in the step a2. A free ion concentration of metals serves as a measurement index of the data. If original data takes mass of an ionic compound as a toxicity endpoint index, the mass needs to be divided by the molecular weight to obtain a value and the value is transformed into a micromole concentration in a unified manner, that is, μmol/L. In a data compilation process, the molecular formulas of the nano-crystalline metal oxides, the types of the tested cells, the toxicity effect types, the endpoint indexes, the test conditions, the exposure time, the data sources and other information are recorded and sorted in an Excel form to serve as a modeling basis.

Data screening, calculating and summarizing are performed by taking a cell viability toxicity endpoint of Escherichia coli as an example. Results are shown in Table 1.

A data source in Table 1 is:

TABLE 1
Cytotoxicity data screening, calculating and summarizing
examples of nano-crystalline metal oxides

| Types of nano- | Endpoint | | Experiment | | Exposure |
|---|---|---|---|---|---|
| crystalline metals | (μmol/L) | Tested organism | condition | Effect type | time |
| Zinc oxide | 3.45 | Escherichia coli | Incubating under | Characterizing | 8-12 hours |
| Copper oxide | 3.20 | | conditions of a | cell viability | |
| Yttria | 2.87 | | temperature of | through a | |
| Bismuth trioxide | 2.82 | | 25° C. and a | mineralizaion | |
| Indium sesquioxide | 2.81 | | rotation speed of | rate of | |
| Alumina | 2.49 | | 150 rpm for 2 | non-autotrophic | |
| Iron sesquioxide | 2.29 | | hours | glucose of | |
| Stannic oxide | 2.01 | | | bacteria | |
| Titanium oxide | 1.74 | | | | |
| Vanadium trioxide | 3.14 | | | | |
| Antimonous oxide | 2.64 | | | | |
| Zirconium dioxide | 2.15 | | | | |
| Cobalt dioxide | 3.51 | | | | |
| Nickel oxide | 3.45 | | | | |
| Dichromium trioxide | 2.51 | | | | |
| Lanthanum trioxide | 2.87 | | | | |

PuzynT. etal. Using nano-QSAR to predict the cytotoxicity of metal oxides, Nature Nanotechnology. 6: 175-178.

step b, establishing a structural descriptor dataset of the nano-crystalline metal oxides:

establishing a structural descriptor set of metal ions, combining a quantum chemistry semi-empirical method and document statistics, and calculating 26 physicochemical structural parameters, including physicochemical parameters of metal ions, physicochemical parameters of metal nanoparticles, scale parameters and thermodynamic parameters, of nanoscale metal oxides of 30-100 nm. The structural descriptor set respectively comprises a soft index of metal ion σp, a soft index per unit charge σP/Z, an atomic number AN, an ion radius r, IP: ionic potential of O_{N}-state ion, IP(N+1): ionic potential of O_{N+1}-state ion, a difference ΔIP of IP(N+1) and IP, an atomic radius R, an atomic weight AW, a Pauling electronegativity Xₘ, a covalence index Xₘ²r, an atomic ionization potential AN/ΔIP, a first hydrolysis constant |log K_{OH}|, an electrochemical potential ΔE₀, an atomic size AR/AW, measured electronegativity x, polarizability z/rx, ionic valency Z, polarizing force parameters Z/r, Z/r² and Z²/r, polarizing force-like parameters Z/AR and Z/AR², a formation enthalpy ΔHme⁺ of gaseous cations, an energy barrier GAP and standard heat of formation HoF of an oxide cluster, wherein the ΔHme⁺, the GAP and the HoF are completed by utilizing a PM6 semi-empirical algorithm in MOPAC quantum chemistry software;

step b1, taking a toxicity endpoint as a dependent variable, performing linear correlation analysis by taking a structural parameter corresponding to each nano-crystalline metal oxide as an independent variable, and calculating a Pearson's correlation coefficient r according to a formula (1) as follows:

$$r = \frac{{\sum }_{i = 1}^{n} ( {x}_{i} - \overline{x} ) ( {y}_{i} - \overline{y} )}{\sqrt{{\sum }_{i = 1}^{n} {( {x}_{i} - \overline{x} )}^{2} {( {y}_{i} - \overline{y} )}^{2}}} \qquad ( 1 )$$

in the formula, xᵢ and yᵢ respectively represent a structural parameter and a measured toxicity value corresponding to the ith metal; and x̅ and y̅ respectively represent the average value of each structural parameter and measured toxicity value. The correlation coefficient r>0.8 is a significant correlation parameter. A correlative extent between two factors can be simply and objectively measured by adopting Pearson's correlation. In the step, structural parameters in significant correlation to toxicity are screened through the correlation coefficient r, thereby preventing pseudo-correlation parameters from being introduced into the model.

The Pearson's correlation coefficient r of each structural parameter is respectively calculated according to the method in the step a1, as shown in Table 2.

TABLE 2
Pearson's correlation coefficients among various parameters

| | ΔHme⁺ | σP | σP/Z | AN | r | ΔIP | ΔE₀ | Xm | \|logK_{OH}\| | X²mr | Z²/r | AN/ΔIP | AR | IP |
|---|---|---|---|---|---|---|---|---|---|---|---|---|---|---|
| ΔHme⁺ | 1.000 | −.607 | −.974 | .175 | −.209 | .349 | −.018 | −.037 | −.839 | −.097 | .896 | −.135 | −.204 | .945 |
| σP | | 1.000 | .649 | −.212 | .151 | .253 | .656 | −.455 | .367 | −.278 | −.405 | −.147 | .412 | −.590 |
| σP/Z | | | 1.000 | −.272 | .066 | −.245 | .024 | .075 | .854 | .053 | −.848 | .057 | .281 | −.925 |
| AN | | | | 1.000 | .852 | −.325 | −.230 | .378 | −.333 | .784 | −.114 | .854 | −.351 | .006 |
| r | | | | | 1.000 | −.316 | .026 | .075 | −.008 | .605 | −.393 | .736 | −.211 | −.313 |
| ΔIP | | | | | | 1.000 | .569 | −.494 | −.244 | −.515 | .545 | −.609 | .287 | .401 |
| ΔE₀ | | | | | | | 1.000 | −.812 | −.078 | −.632 | .159 | −.495 | .384 | .044 |
| Xm | | | | | | | | 1.000 | .069 | .831 | −.320 | .667 | −.293 | −.158 |
| \|logK_{OH}\| | | | | | | | | | 1.000 | −.026 | −.711 | −.105 | .303 | −.758 |
| X²mr | | | | | | | | | | 1.000 | −.419 | .945 | −.371 | −.245 |
| Z²/r | | | | | | | | | | | 1.000 | −.457 | −.176 | .961 |
| AN/ΔIP | | | | | | | | | | | | 1.000 | −.343 | .294 |
| AR | | | | | | | | | | | | | 1.000 | −.288 |
| IP | | | | | | | | | | | | | | 1.000 |
| IP(N + 1) | | | | | | | | | | | | | | |
| AW | | | | | | | | | | | | | | |
| AR/AW | | | | | | | | | | | | | | |
| Z | | | | | | | | | | | | | | |
| Z/r² | | | | | | | | | | | | | | |
| Z/AR² | | | | | | | | | | | | | | |
| Z/r | | | | | | | | | | | | | | |
| Z/AR | | | | | | | | | | | | | | |
| x | | | | | | | | | | | | | | |
| z/rx | | | | | | | | | | | | | | |
| GAP | | | | | | | | | | | | | | |
| HoF | | | | | | | | | | | | | | |

| | IP(N + 1) | AW | AR/AW | Z | Z/r² | Z/AR² | Z/r | Z/AR | x | z/rx | GAP | HoF |
|---|---|---|---|---|---|---|---|---|---|---|---|---|
| ΔHme⁺ | .591 | .186 | −.074 | .912 | .718 | .759 | .856 | .855 | −.041 | .699 | −.510 | −.021 |
| σP | .021 | −.215 | .341 | −.361 | −.294 | −.489 | −.361 | −.461 | −.452 | −.084 | .239 | −.509 |
| σP/Z | −.498 | −.284 | .221 | −.911 | −.599 | −.794 | −.773 | −.877 | .080 | −.651 | .438 | −.016 |
| AN | −.267 | .998 | −.777 | .197 | −.506 | .292 | −.302 | .273 | .376 | −.355 | .113 | .245 |
| r | −.362 | .850 | −.705 | −.062 | −.769 | .031 | −.588 | .000 | .074 | −.467 | .335 | .033 |
| ΔIP | .956 | −.298 | .652 | .454 | .600 | .162 | .582 | .288 | −.494 | .672 | −.104 | −.609 |
| ΔE₀ | .457 | −.228 | .310 | .223 | .149 | −.069 | .176 | .044 | −.812 | .459 | .174 | −.666 |
| Xm | −.459 | .366 | −.252 | −.325 | −.241 | −.057 | −.297 | −.167 | 1.000 | −.639 | −.229 | .775 |
| \|logK_{OH}\| | −.444 | −.349 | .159 | −.805 | −.522 | −.711 | −.666 | −.780 | .074 | −.592 | .374 | −.011 |
| X²mr | −.504 | .778 | −.562 | −.241 | −.568 | .018 | −.509 | −.082 | .831 | −.715 | −.017 | −.618 |
| Z²/r | .758 | −.100 | .115 | .934 | .847 | .766 | .964 | .868 | −.322 | .911 | −.415 | −.324 |
| AN/ΔIP | −.598 | .848 | −.665 | −.216 | −.657 | .012 | −.564 | −.076 | .666 | −.688 | .062 | .533 |
| AR | .145 | −.354 | .549 | −.231 | .079 | −.725 | −.048 | −.554 | −.292 | .059 | −.105 | −.231 |
| IP | .652 | .024 | .000 | .918 | .784 | .821 | .913 | .896 | −.161 | .800 | −.470 | −.132 |
| IP(N + 1) | 1.000 | −.239 | .540 | .669 | .747 | .396 | .774 | .525 | −.461 | .812 | −.237 | −.546 |
| AW | | 1.000 | −.752 | .209 | −.487 | .305 | −.286 | .286 | .364 | −.338 | .120 | .232 |
| AR/AW | | | 1.000 | −.138 | .545 | −.365 | .322 | −.295 | −.251 | .332 | −.173 | −.247 |
| Z | | | | 1.000 | .636 | .830 | .834 | .936 | −.328 | .818 | −.360 | −.319 |
| Z/r² | | | | | 1.000 | .435 | .954 | .531 | −.242 | .845 | −.499 | −.215 |
| Z/AR² | | | | | | 1.000 | .636 | .973 | −.060 | .551 | −.218 | −.093 |
| Z/r | | | | | | | 1.000 | .742 | −.299 | .916 | −.489 | −.273 |
| Z/AR | | | | | | | | 1.000 | −.170 | .682 | −.284 | −.190 |
| x | | | | | | | | | 1.000 | −.641 | −.229 | .777 |
| z/rx | | | | | | | | | | 1.000 | −.306 | −.549 |
| GAP | | | | | | | | | | | 1.000 | −.246 |
| HoF | | | | | | | | | | | | 1.000 |

in the step b2, the optimal structural descriptor combination is obtained through principal component analysis on premise of significant correlation. A specific formula is as follows:

F=a₁ᵢ*Z_{X1}+a₂ᵢ*Z_{X2}+ . . . +aₚᵢ*Z_{Xp} (2)

wherein a₁ᵢ, a₂ᵢ, . . . , aₚᵢ(i=1, . . . , m) are characteristic vectors corresponding to characteristic values of a covariance matrix Σ of X, and Z_{X1}, Z_{X2}, . . . , Z_{Xp} are values obtained by performing standardized processing on original variables;

A=(aᵢⱼ)_{p×m}=(a₁,a₂, . . . , aₘ) (3)

Rₐᵢ=λᵢₐᵢ (4)

R is a correlation coefficient matrix; λᵢ and aᵢ are a corresponding characteristic value and a unit characteristic vector; and λ1≥λ2≥ . . . ≥λp≥0.

The principal component analysis is to delete excessive variables in a close relationship from all the originally proposed variables and establish new variables as few as possible, so that every two of the new variables are uncorrelated. Moreover, original information of the new variables may be maintained as much as possible.

The Pearson's correlation coefficient r of each structural parameter is respectively calculated according to the method in the step b2, as shown in Table 3.

TABLE 3
Principal component analysis of structural parameters

| | | Principal component analysis | | | |
|---|---|---|---|---|---|
| Structural | | 1 | 2 | 3 | 4 |
| descriptor | Physicochemical significance | 43.170 | 71.583 | 84.537 | 90.137 |
| ΔHme⁺ | Formation enthalpy of gaseous | 0.812 | 0.524 | −0.088 | 0.139 |
| | cations | | | | |
| σP | Metal ion soft index | −0.235 | −0.681 | 0.455 | 0.248 |
| σP/Z | Unit charge soft index | −0.755 | −0.597 | −0.019 | −0.047 |
| AN | Atomic number | −0.292 | 0.780 | 0.479 | 0.252 |
| r | Ion radius | −0.479 | 0.429 | 0.722 | 0.151 |
| ΔIP | difference of IP(N + 1) and IP | 0.678 | −0.390 | 0.153 | 0.408 |
| ΔE₀ | Electrochemical potential | 0.352 | −0.569 | 0.601 | 0.162 |
| Xm | Pauling electronegativity | −0.492 | 0.579 | −0.566 | 0.194 |
| \|logK_{OH}\| | First hydrolysis constant | −0.652 | −0.556 | −0.127 | −0.187 |
| Xm²r | Covalence index | −0.605 | 0.722 | −0.043 | 0.275 |
| Z²/r | Polarizing force parameter 1 | 0.962 | 0.231 | −0.029 | −0.037 |
| AN/ΔIP | Atomic ionization potential | −0.626 | 0.703 | 0.159 | 0.227 |
| AR | Atomic radius | −0.030 | −0.643 | −0.066 | 0.549 |
| IP | Ionic potential of O_{N}-state ion | 0.888 | 0.420 | −0.110 | −0.053 |
| IP(N + 1) | Ionic potential of O_{N+1}-state ion | 0.845 | −0.189 | 0.091 | 0.321 |
| AW | Atomic weight | −0.273 | 0.779 | 0.483 | 0.262 |
| AR/AW | Atomic size | 0.311 | −0.722 | −0.404 | 0.329 |
| Z | Ionic valency | 0.869 | 0.407 | 0.240 | 0.047 |
| Z/r² | Polarizing force parameter 2 | 0.893 | −0.094 | −0.401 | 0.061 |
| Z/AR² | Polarizing force-like parameter 1 | 0.643 | 0.629 | 0.164 | −0.290 |
| Z/r | Polarizing force parameter 3 | 0.968 | 0.088 | −0.206 | 0.021 |
| Z/AR | Polarizing force-like parameter 2 | 0.760 | 0.570 | 0.205 | −0.163 |
| x | Measured electronegativity | −0.495 | 0.576 | −0.567 | 0.193 |
| z/rx | Polarizability | 0.974 | −0.138 | 0.096 | −0.043 |
| GAP | Energy barrier | −0.384 | −0.226 | 0.490 | −0.389 |
| HoF | Standard heat of formation of an | −0.439 | 0.501 | −0.575 | 0.034 |
| | oxide cluster | | | | |

step c, establishing a toxicity prediction model and checking robustness;

step c1 establishing a multiple regression equation and estimating parameters;

two optimal structural parameters determined in the above step d refer to the independent variable X; a cytotoxicity value of the metal oxide is a dependent variable Y; a QICAR equation Y=XB+E of each model organism s established by utilizing a multiple linear regression analysis method, as shown in the following formula (5):

$$Y = ( \begin{matrix}{y}_{1} \\ {y}_{2} \\ ⋮ \\ {y}_{n}\end{matrix} ) , X = ( \begin{matrix}1 & {x}_{11} & {x}_{12} \\ 1 & {x}_{21} & {x}_{22} \\ ⋮ & ⋮ & ⋮ \\ 1 & {x}_{n 1} & {x}_{n 2}\end{matrix} ) , B = [ \begin{matrix}{β}_{0} \\ {β}_{1} \\ {β}_{2}\end{matrix} ] , E = ( \begin{matrix}{ɛ}_{1} \\ {ɛ}_{2} \\ ⋮ \\ {ɛ}_{n}\end{matrix} ) \qquad ( 5 )$$

wherein n is a number of observed values; B represents an unknown parameter and needs to be estimated in the equation through a least square method; and E represents a random error term and reflects an influence of random factors on y except a linear relationship of x₁ and x₂ on y. Compared with unary linear regression, in the equation (5), a relationship between two different structural parameters and the toxicity value is established by adopting multiple linear regression, and a relationship between a predicted object and correlative factors is completely and accurately expressed;

parameters in the equation are estimated by adopting the least square method, and X′ is a transposed matrix of X:

$$\hat{B} = ( \begin{matrix}{\hat{β}}_{0} \\ {\hat{β}}_{1} \\ … \\ {\hat{β}}_{m}\end{matrix} ) = {( {X}^{′} X )}^{- l} {X}^{′} Y \qquad ( 6 )$$

least square regression is to perform parameter estimation on a regression model from an error fitting angle, is a standard multiple modeling tool, and is particularly applicable to prediction analysis.

step c2, performing goodness-of-fit test and significance test of the regression equation (F test);

goodness-of-fit test indexes of the model include: square R²) of the correlation coefficient and correlation coefficient (R̅²) of degree-of-freedom correction, and a standard deviation of (RMSF), and indexes of F test are a value F and correlative probability p (Significance F) calculated by multi-factor variance analysis (Multi-ANOVA). Generally, test is performed by adopting the value P corresponding to the statistic F;

step c3, judgment standards: according to a toxicity data acquisition way, in vitro test R²≥0.81 and in vivo test R²≥0.64; a significance level is α, and when p<α, the regression equation is significant;

$$\begin{matrix}{R}^{2} = 1 - \frac{{\sum }_{i = 1}^{n} {( {y}_{i} - {y}^{⋒} )}^{2}}{{\sum }_{i = 1}^{n} {( {y}_{i} - \overline{y} )}^{2}} \\ \overline{{R}^{2}} = 1 - ( 1 - {R}^{2} ) \frac{n - 1}{n - 3} & ( 7 ) \\ RMSE = \sqrt{\frac{{\sum }_{i = 1}^{n} {( {y}_{i} - \hat{y} )}^{2}}{n - 3}} & ( 8 ) \\ \begin{matrix}F = \frac{[ SS ( total ) - SS ( residual ) ] \text{/} 2}{SS ( residual ) \text{/} ( n - 3 )} \\ = \frac{[ {\sum }_{i = 1}^{n} {( {y}_{i} - \overline{y} )}^{2} - {\sum }_{i = 1}^{n} {( {y}_{i} - \hat{y} )}^{2} ] ( n - 3 )}{2 \times {\sum }_{i = 1}^{n} {( {y}_{i} - \hat{y} )}^{2}}\end{matrix} & ( 9 )\end{matrix}$$

in the formula, yᵢ represents a measured toxicity value of the ith metal, ŷ represents a predicted toxicity value of the ith metal, y̅ represents the average value of each toxicity value, and n is a number of metals in a training set;

the correlation coefficient and standard deviation in the equations (7) and (8) can measure goodness of fit of a regression straight line; and the equation (9) is a universal method for testing whether a linear relationship between the dependent variable and the multiple independent variables is significant;

step d, performing internal validation on a QSAR model;

A QSAR model of each species may be validated by adopting a leave-one-out method. A core concept of the method is to randomly take a data from the training set, establish a multiple regression model by using other toxicity data and the optimal structural descriptor obtained in the step c and check an established network model according to comparison of a predicted value of the taken data with an experimental value. In order to reduce variability of cross validation results, a sample dataset is differently divided for multiple times to obtain different complementary subsets and perform multiple cross validations. In the step, the average value of multiple validations is taken as a validation result.

The internal validation method has the advantages that: the model is trained by using almost all the samples and is closest to the sample, so that an assessed result is relatively reliable. Any random factor does not exist in the experiment, and the whole process is repeatable.

Specific steps are as follows:

step d1, taking a sample as a prediction set in given modeling samples, modeling the rest samples serving as a training set, and calculating a prediction error of the sample;

step d2, recording the sum of squares of prediction errors in each equation until all the samples are forecast once only;

step d3, calculating a cross validation correlation coefficient Q²_{cv} and a cross validation root-mean-square error RMSECV, wherein calculation formulas are as follows; and the determining criteria include Q²_{cv}>0.6 and R²−Q²_{cv}≤0.3;

$$\begin{matrix}{Q}_{CV}^{2} = 1 - \frac{{\sum }_{i = 1}^{n} {( {y}_{i}^{o bs} - {y}_{i}^{predev} )}^{2}}{{\sum }_{i = 1}^{n} {( {y}_{i}^{obs} - {\overline{y}}^{obs} )}^{2}} & ( 10 ) \\ RMSECV = \sqrt{\frac{{\sum }_{i = 1}^{n} {( {y}_{i}^{o bs} - {y}_{i}^{predev} )}^{2}}{n}} & ( 11 )\end{matrix}$$

in the formula, yᵢ^{obs} represents a measured toxicity value of the ith compound; yᵢ^{predcv} represents a predicted toxicity value of the ith compound, y̅^{obs} represents an average value of toxicity of the training set, and n represents a number of compounds in the training set;

equations (10) and (11) are indicator parameters of leave-one-out interval validation; over-fitting of the mode on data of the training set can be effectively reduced; and existence of an influence of a specific metal on robustness of the model in the training set is determined.

The model is subjected to internal validation by adopting the method in the step d. By taking a prediction equation Pred.MLR=(4.412±0.165)+(−0.001±2.57×10−4)ΔHme⁺+(−0.121±0.068) Z/r as an example, the model is subjected to leave-one-out interval validation and related fitting parameters are shown in Table 4. According to the formulas (7) and (8) in the step d3, Q²_{cv}=0.7422, RMSECV=0.2695 and R²−Q²_{cv}=0.8793−0.7422=0.1371 are calculated. If model robustness determining criterions of Q²_{cv}>0.6 and R²−Q²_{cv}≤0.3 are met, the model passes the internal validation.

TABLE 4
Leave-one-out correlation parameters for interval validation of the model

| | | | Observed | | | | Correlation | Predicted |
|---|---|---|---|---|---|---|---|---|
| Metals | ΔHme⁺ | Z/r | value | Coefficient 1 | Coefficient 2 | Intercept | coefficient | value |
| Zinc | 662.44 | 2.703 | 3.45 | −0.00103 | −0.1236 | 4.3951 | 0.8632 | 3.38 |
| oxide | | | | | | | | |
| Copper | 713.74 | 2.740 | 3.20 | −0.00107 | −0.1279 | 4.4700 | 0.8784 | 3.36 |
| oxide | | | | | | | | |
| Yttria | 837.15 | 3.333 | 2.87 | −0.00109 | −0.1236 | 4.4857 | 0.8993 | 3.16 |
| Bismuth | 1137.40 | 2.913 | 2.82 | −0.00101 | −0.13615 | 4.4303 | 0.8798 | 2.88 |
| trioxide | | | | | | | | |
| Indium | 1271.13 | 3.750 | 2.81 | −0.00117 | −0.09402 | 4.4115 | 0.8913 | 2.57 |
| sesquioxide | | | | | | | | |
| Alumina | 1187.83 | 5.556 | 2.49 | −0.00105 | −0.12513 | 4.4207 | 0.8770 | 2.48 |
| Iron | 1363.40 | 5.455 | 2.29 | −0.00105 | −0.12256 | 4.4164 | 0.8725 | 2.32 |
| sesquioxide | | | | | | | | |
| Stannic | 1717.32 | 5.797 | 2.01 | −0.00113 | −0.11686 | 4.4664 | 0.8654 | 1.85 |
| oxide | | | | | | | | |
| Titanium | 1575.73 | 6.557 | 1.74 | −0.00108 | −0.08975 | 4.3276 | 0.8613 | 2.04 |
| oxide | | | | | | | | |
| Vanadium | 1097.73 | 4.688 | 3.14 | −0.00094 | −0.15946 | 4.4096 | 0.9397 | 2.63 |
| trioxide | | | | | | | | |
| Antimonous | 1233.06 | 3.947 | 2.64 | −0.00105 | −0.12382 | 4.4200 | 0.8787 | 2.64 |
| oxide | | | | | | | | |
| Zirconium | 1357.66 | 5.556 | 2.15 | −0.00107 | −0.11051 | 4.39356 | 0.8758 | 2.33 |
| dioxide | | | | | | | | |
| Cobalt | 594.59 | 3.077 | 3.51 | 0.00098 | −0.13311 | 4.37739 | 0.8622 | 4.55 |
| dioxide | | | | | | | | |
| Nickel | 596.88 | 2.899 | 3.45 | −0.00104 | −0.12506 | 4.41298 | 0.8619 | 3.43 |
| oxide | | | | | | | | |
| Chromium | 1266.62 | 4.839 | 2.51 | −0.00105 | −0.12450 | 4.42118 | 0.8775 | 2.49 |
| oxide | | | | | | | | |
| Lanthanum | 1017.22 | 2.913 | 2.87 | −0.00099 | −0.14381 | 4.45000 | 0.8837 | 3.02 |
| trioxide | | | | | | | | |

step e, calculating an application field of the model;

the application field of the model is calculated by adopting a leverage value method with respect to the validated model, and is visually represented by a Williams diagram. The method may ensure that the model has the optimal reliability in a prediction process.

a calculation formula of the leverage value h, is as follows:

hᵢ=xᵢ^{T}(X^{T}X)⁻¹xᵢ (12)

in the formula, xᵢ represents a column vector composed of structural parameters of the ith metal; for a two-parameter model,

$${x}_{j} = ( \begin{matrix}{x}_{i 1} \\ {x}_{i 2}\end{matrix} ) , X = ( \begin{matrix}{x}_{11} & {x}_{12} \\ {x}_{21} & {x}_{22} \\ ⋮ & ⋮ \\ {x}_{n 1} & {x}_{n 2}\end{matrix} ) ,$$

X^{T} represents a transposed matrix of the matrix X, and (X^{T}X)⁻¹ represents an inverse matrix of a matrix X^{T}X;

a calculation formula of a critical value h* is as follows:

$${h}^{*} = \frac{3 ( p + 1 )}{n} \qquad ( 13 )$$

in the formula, p represents a variable number in the model; p is equal to 2 in the two-parameter model; and n represents a number of compounds in the model training set, and is determined according to a number of metal oxides in the training set in the QSAR equation after test in the steps a-d;

a Williams diagram is drawn by taking the leverage value h as a horizontal coordinate and a standardized residual of each data point as a vertical coordinate. A coordinate space of h<h* in the diagram is the application field of the model.

Structural parameters and toxicity endpoints of various nano-crystalline metal oxides in the training set are shown in Table 5. A critical value is h*=3*(2+1)/16=0.5625.

TABLE 5
Calculation of application field of toxicity prediction
model of nano-crystalline metal oxides

| | | | | | Observed | Predicted | Standardized |
|---|---|---|---|---|---|---|---|
| Type | Z/r | h(Z/r) | ΔHme⁺ | h(ΔHme⁺) | value | value | residual |
| Zinc | 2.703 | 0.14664 | 662.44 | 0.17261 | 3.45 | 3.39 | 0.06 |
| oxide | | | | | | | |
| Copper | 2.740 | 0.14213 | 713.74 | 0.15188 | 3.20 | 3.35 | −0.15 |
| oxide | | | | | | | |
| Yttria | 3.333 | 0.08999 | 837.15 | 0.10281 | 2.87 | 3.13 | −0.26 |
| Bismuth | 2.913 | 0.12433 | 1137.40 | 0.0631 | 2.82 | 2.87 | −0.05 |
| trioxide | | | | | | | |
| Indium | 3.750 | 0.06938 | 1271.13 | 0.07807 | 2.81 | 2.62 | 0.19 |
| sesquioxide | | | | | | | |
| Alumina | 5.556 | 0.1376 | 1187.83 | 0.06638 | 2.49 | 2.46 | 0.03 |
| Iron | 5.455 | 0.12618 | 1363.40 | 0.11434 | 2.29 | 2.25 | 0.04 |
| sesquioxide | | | | | | | |
| Stannic | 5.797 | 0.16579 | 1717.32 | 0.27364 | 2.01 | 1.89 | 0.12 |
| oxide | | | | | | | |
| Titanium | 6.557 | 0.28462 | 1575.73 | 0.18731 | 1.74 | 1.95 | −0.21 |
| oxide | | | | | | | |
| Vanadium | 4.688 | 0.07299 | 1097.73 | 0.06253 | 3.14 | 2.69 | 0.45 |
| trioxide | | | | | | | |
| Antimonous | 3.947 | 0.06439 | 1233.06 | 0.07176 | 2.64 | 2.62 | 0.02 |
| oxide | | | | | | | |
| Zirconium | 5.556 | 0.1376 | 1357.66 | 0.09848 | 2.15 | 2.31 | −0.16 |
| dioxide | | | | | | | |
| Cobalt | 3.077 | 0.10878 | 594.59 | 0.20487 | 3.51 | 3.39 | 0.12 |
| dioxide | | | | | | | |
| Nickel | 2.899 | 0.12531 | 596.88 | 0.20778 | 3.45 | 3.42 | 0.03 |
| oxide | | | | | | | |
| Chromium | 4.839 | 0.07993 | 1266.62 | 0.07762 | 2.51 | 2.48 | 0.03 |
| sesquioxide | | | | | | | |
| Lanthanum | 2.913 | 0.12433 | 1017.22 | 0.06682 | 2.87 | 3.04 | −0.17 |
| trioxide | | | | | | | |

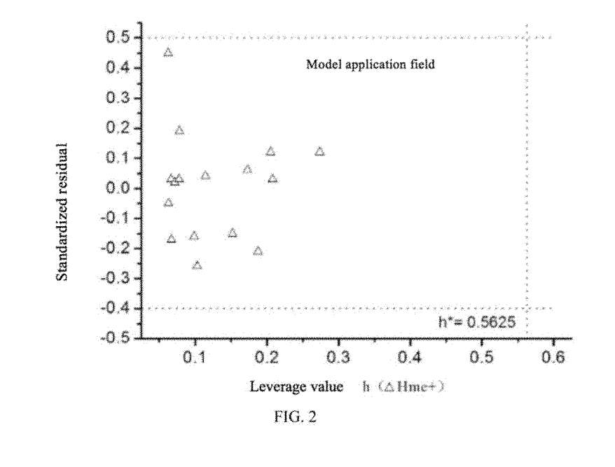

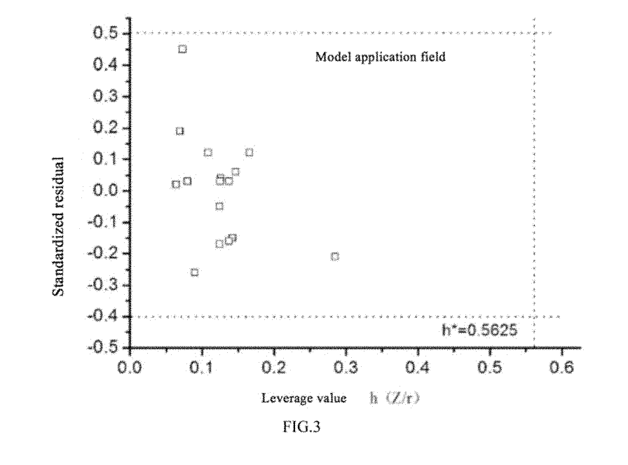

The Williams diagram is drawn by taking leverage values of two optimal structural parameters of each metal as a horizontal coordinate and taking a predicted residual as a vertical coordinate, as shown in FIG. 2 and FIG. 3. A space inside three imaginary lines in the diagram is the application field of the model, and a calculation result shows that 16 nano-crystalline metal oxides in the training set are in the predicted range of the model.

Step f, obtaining a nano QSAR prediction equation according to method in the a bone steps a-e, searching and sorting values of all structural descriptors of to-be-predicted nano-crystalline metal oxides, and substituting the values into the equations to calculate the to-be-predicted toxicity endpoint.

We claim:

1. A QSAR toxicity prediction method for evaluating health effects of nano-crystalline metal oxides, for predicting a toxicity endpoint of unknown nano-crystalline metal oxides according to a quantitative relationship between structural characteristics and cytotoxicity of the nano-crystalline metal oxides,
specifically comprising the following steps:
step a, acquiring, screening, calculating and summarizing modeling toxicity data;
step b, establishing a structural descriptor dataset of nano-crystalline metal oxides, and performing linear regression analysis and principal component analysis by taking a structural parameter corresponding to each metal oxide as an independent variable, thereby obtaining an optimal structural descriptor combination;
step c, establishing a toxicity prediction model and checking robustness; establishing a multiple regression equation, estimating parameters, and checking by adopting a value P corresponding to a statistic F;
step d, performing internal validation on a QSAR model;
step e, calculating an application field of the model; and drawing a Williams diagram by taking a leverage value h as a horizontal coordinate, taking a standardized residual of each data point as a vertical coordinate by virtue of the tested model; and
step f, rapidly screening and predicting the toxicity of an unknown nano nano-crystalline metal oxides.

2. The CSAR toxicity prediction method for evaluating health effects of nano-crystalline metal oxides according to claim 1, wherein in the step b, established structural descriptor dataset of the nano-crystalline metal oxides respectively comprises a soft index of metal ion σp, a soft index per unit charge σP/Z, an atomic number AN, an ion radius r, IP: ionic potential of O_{N}-state ion, IP(N+1): ionic potential of O_{N+1}-state ion, a difference ΔIP of IP(N+1) and IP, an atomic radius R, an atomic weight AW, a Pauling electronegativity Xₘ, a covalence index Xₘ²r, an atomic ionization potential AN/ΔIP, a first hydrolysis constant |log K_{OH}|, an electrochemical potential ΔE₀, an atomic size AR/AW, measured electronegativity x, polarizability z/rx, ionic valency Z, polarizing force parameters Z/r, Z/r² and Z²/r, polarizing force-like parameters Z/AR and Z/AR², a formation enthalpy ΔHme⁺ of gaseous cations, an energy barrier GAP and standard heat of formation HoF of an oxide cluster.

3. The QSAR toxicity prediction method for evaluating health effects of nano-crystalline metal oxides according to claim 1, wherein the step b specifically comprises the processes as follows:
step b1, taking a toxicity endpoint as a dependent variable, performing linear regression analysis by taking a structural parameter corresponding to each metal oxide as an independent variable, and calculating a correlation coefficient r according to a formula (1) as follows:
$$r = \frac{{\sum }_{i = 1}^{n} ( {x}_{i} - \overline{x} ) ( {y}_{i} - \overline{y} )}{\sqrt{{\sum }_{i = 1}^{n} {( {x}_{i} - \overline{x} )}^{2} {( {y}_{i} - \overline{y} )}^{2}}} \qquad ( 1 )$$
in the formula, x̅ and y̅ respectively represent the average values of structural parameters and toxicity values, and xᵢ and yᵢ respectively represent a structural parameter and a toxicity value corresponding to the ith metal;
the correlation coefficient r>0.8 is a significant correlation parameter;
in the step b2, the optimal structural descriptor combination is obtained through principal component analysis on premise of significant correlation; a specific formula is as follows:
F=a₁ᵢ*Z_{X1}+a₂ᵢ*Z_{X2}+ . . . +aₚᵢ*Z_{Xp} (2)
wherein a₁ᵢ, a₂ᵢ, . . . , aₚᵢ(i=1, . . . , m) are characteristic vectors corresponding to characteristic values of a covariance matrix Σ of X, and Z_{X1}, Z_{X2}, . . . , Z_{Xp} are values obtained by performing standardized processing on original variables;
A=(aᵢⱼ)_{p×m}=(a₁,a₂, . . . , aₘ) (3)
Rₐᵢ=λᵢₐᵢ (4)
R is a correlation coefficient matrix; λᵢ and ₐᵢ are a corresponding characteristic value and a unit characteristic vector; and λ1≥λ2≥ . . . ≥λp≥0.

4. The QSAR toxicity prediction method for evaluating health effects of nano-crystalline metal oxides according to claim 1, wherein the step c comprises the following process:
step c1, establishing the multiple regression equation and estimating the parameters,
wherein two optimal structural parameters determined in the step c refer to the independent variable X; a cytotoxicity value of the metal oxide is a dependent variable Y; a QICAR equation Y=XB+E of each model organism is established by utilizing a multiple linear regression analysis method, as shown in a formula (5):
$$Y = ( \begin{matrix}{y}_{1} \\ {y}_{2} \\ ⋮ \\ {y}_{n}\end{matrix} ) , X = ( \begin{matrix}1 & {x}_{11} & {x}_{12} \\ 1 & {x}_{21} & {x}_{22} \\ ⋮ & ⋮ & ⋮ \\ 1 & {x}_{n 1} & {x}_{n 2}\end{matrix} ) , B = [ \begin{matrix}{β}_{0} \\ {β}_{1} \\ {β}_{2}\end{matrix} ] , E = ( \begin{matrix}{ɛ}_{1} \\ {ɛ}_{2} \\ ⋮ \\ {ɛ}_{n}\end{matrix} ) \qquad ( 5 )$$
wherein n is a number of observed values;
parameters in the equation are estimated by adopting a least square method, and X′ is a transposed matrix of X:
$$\hat{B} = ( \begin{matrix}{\hat{β}}_{0} \\ {\hat{β}}_{1} \\ … \\ {\hat{β}}_{m}\end{matrix} ) = {( {X}^{′} X )}^{- l} {X}^{′} Y \qquad ( 6 )$$
step c2, performing goodness-of-fit test and significance test of the regression equation, and testing by adopting the F;
goodness-of-fit test indexes of the model refer to: square R² of the correlation coefficient and correlation coefficient R̅² of degree-of-freedom correction, and a standard deviation of RMSE;
indexes of F test refer to a value F and correlative probability p (Significance F) calculated by multi-factor variance analysis (Multi-ANOVA); and test is performed by adopting the value P corresponding to the statistic F;
step c3, judgment standards: according to a toxicity data acquisition way, in vitro test R²≥0.81. and in vivo test R²≥0.64; a significance level is α, and when p<α, the regression equation is significant.

5. The QSAR toxicity prediction method for evaluating health effects of nano-crystalline metal oxides according to claim 4, wherein calculation is made in the step c3 according to a formula as follows:
$$\begin{matrix}{R}^{2} = 1 - \frac{{\sum }_{i = 1}^{n} {( {y}_{i} - {y}^{⋒} )}^{2}}{{\sum }_{i = 1}^{n} {( {y}_{i} - \overline{y} )}^{2}} \\ \overline{{R}^{2}} = 1 - ( 1 - {R}^{2} ) \frac{n - 1}{n - 3} & ( 7 ) \\ RMSE = \sqrt{\frac{{\sum }_{i = 1}^{n} {( {y}_{i} - {y}^{⋒} )}^{2}}{n - 3}} & ( 8 ) \\ \begin{matrix}F = \frac{[ SS ( total ) - SS ( residual ) ] \text{/} 2}{SS ( residual ) \text{/} ( n - 3 )} \\ = \frac{[ {\sum }_{i = 1}^{n} {( {y}_{i} - \overline{y} )}^{2} - {\sum }_{i = 1}^{n} {( {y}_{i} - \hat{y} )}^{2} ] ( n - 3 )}{2 \times {\sum }_{i = 1}^{n} {( {y}_{i} - \hat{y} )}^{2}}\end{matrix} & ( 9 )\end{matrix}$$
in the formula, R² represents the square of the correlation coefficient, R̅² represents a correlation coefficient of degree-of-freedom correction, and RMSE represents the standard deviation.

6. The QSAR toxicity prediction method for evaluating health effects of nano-crystalline metal oxides according to claim 1, wherein the step d comprises a specific process as follows:
step d1, taking a sample as a prediction set in given modeling samples, modeling the rest samples as a training set, and calculating a prediction error of the sample;
step d2, recording the sum of the squares of prediction errors in each equation until all the samples are forecast once only; and
step d3, calculating a cross validation correlation coefficient Q²_{cv} and a cross validation root-mean-square error RMSECV, wherein the determining criteria include Q²_{cv}>0.6 and R²−Q²_{cv}≤0.3.

7. The QSAR toxicity prediction method for evaluating health effects of nano-crystalline metal oxides according to claim 6, wherein calculation formulas adopted in the step d3 are as follows:
$$\begin{matrix}{Q}_{CV}^{2} = 1 - \frac{{\sum }_{i = 1}^{n} {( {y}_{i}^{o bs} - {y}_{i}^{predev} )}^{2}}{{\sum }_{i = 1}^{n} {( {y}_{i}^{obs} - {\overline{y}}^{obs} )}^{2}} & ( 10 ) \\ RMSECV = \sqrt{\frac{{\sum }_{i = 1}^{n} {( {y}_{i}^{o bs} - {y}_{i}^{predev} )}^{2}}{n}} & ( 11 )\end{matrix}$$
in the formula, yᵢ^{obs} represents a measured value of toxicity of the ith compound, yᵢ^{predcv} represents a predicted value of the toxicity of the ith compound, y̅^{obs} represents an average value of toxicity of the training set, and n represents a number of compounds in the training set.

8. The QSAR toxicity prediction method for evaluating health effects of nano-crystalline metal oxides according to claim 1, wherein in the step e, a calculation formula of the leverage value hi is as follows:
hᵢxᵢ^{T}(X^{T}X)⁻¹xᵢ (12)
in the formula, xᵢ represents a column vector composed of structural parameters of the ith metal; for a two-parameter model,
$${x}_{j} = ( \begin{matrix}{x}_{i 1} \\ {x}_{i 2}\end{matrix} ) , X = ( \begin{matrix}{x}_{11} & {x}_{12} \\ {x}_{21} & {x}_{22} \\ ⋮ & ⋮ \\ {x}_{n 1} & {x}_{n 2}\end{matrix} ) ,$$
X^{T} represents a transposed matrix of the matrix X, and (X^{T}X)⁻¹ represents an inverse matrix of a matrix X^{T}X.

9. The QSAR toxicity prediction method for evaluating health effects of nano-crystalline metal oxides according to claim 8, wherein a calculation formula of a critical value h* is as follows:
$${h}^{*} = \frac{3 ( p + 1 )}{n} \qquad ( 13 )$$
in the formula, p represents a variable number in the model; p is equal to 2 in the two-parameter model; and n represents a number of compounds in the model training set, and is determined according to a number of metal oxides in the training set in the QSAR equation after test in the steps a-d; and
a coordinate space of h<h* in the Williams diagram is the application field of the model.

10. The QSAR toxicity prediction method for evaluating health effects of nano-crystalline metal oxides according to claim 1, wherein a specific process in the step f is as follows: obtaining a nano QSAR prediction equation according to method in the above steps a-e, searching and sorting values of all structural descriptors of to-be-predicted nano-crystalline metal oxides, and substituting the values into the equations to calculate a to-be-predicted toxicity endpoint.
